(19) United States
(12) Patent Application Publication
(10) Pub. No.: US 2026/0005534 A1
(43) Pub. Date: Jan. 1, 2026

(54) Battery Restoration Device

(71) Applicant: Vector Products, Inc., Boca Raton, FL (US)

(72) Inventors: Ling To Shum, Boca Raton, FL (US); Salvador Herrera, Boca Raton, FL (US)

(21) Appl. No.: 19/185,491

(22) Filed: Apr. 22, 2025

Related U.S. Application Data
(60) Provisional application No. 63/664,856, filed on Jun. 27, 2024.

(51) Int. Cl. H02J 7/00; H01M 10/42; H01M 10/44; H01M 10/48

(52) U.S. Cl. CPC H02J 7/0069; H01M 10/425; H01M 10/44; H01M 10/48; H01M 2010/4271

(57) ABSTRACT

A restoration device includes a microprocessor configured to read an initial voltage of the battery and determine if the battery requires restoration. If so, the microprocessor performs a predetermined number of charge cycles. Each charge cycle includes charging the battery for a charge time period. After expiration of the charge time period, a load test is performed for a load time period. After performing the number of charge cycles, the microprocessor reads a current voltage of the battery and compares the current voltage and the initial voltage. The battery is determined to be faulty based on the current voltage not being greater than the initial voltage.

### CROSS-REFERENCE TO RELATED APPLICATIONS

This patent application claims priority to co-pending U.S. Provisional Patent Application Ser. No. 63/664,856 titled “Battery Restoration”, filed on Jun. 27, 2024. The foregoing application is incorporated herein by reference in its entirety.

### TECHNICAL FIELD

The present invention relates to electrical system restoration, and more particularly, to the restoration of batteries.

### BACKGROUND ART

Batteries provide the energy to start combustion and electrical engines and electric motors, among other uses. Due to environmental conditions, improper maintenance, age of the batteries or other conditions, the battery may lose its energy and become unable to provide charging capabilities to these engines and motors. Known apparatuses and methods for automatic recovery of batteries rely on monitoring battery voltage, current and internal resistance during battery charging. In one known apparatus or method, the lead acid battery is recovered for usage by measuring the internal resistance to determine if the internal resistance is either too high for the battery to be recoverable or too low for normal charging methods to be effective. However, these apparatuses and methods depend on the measurement of the internal resistance of the battery while neglecting other charging parameters needed for proper restoration for a battery, such as restoring and raising of the specific gravity of the electrolyte. For starting batteries, known alternative sources include jump-starting systems and battery chargers with capabilities to restore the starting capabilities of the starting battery. However, the battery may be deeply discharged such that the battery chargers are unable to charge the battery.

### SUMMARY OF THE EMBODIMENTS

A restoration device for restoring a battery, includes: a microprocessor configured to: read an initial voltage of the battery; determine if the battery requires restoration; in response to determining that the battery requires restoration, perform a predetermined number of charge cycles, each charge cycle including: charge the battery for a predetermined charge time period; and after expiration of the charge time period, perform a load test for a load time period; after performing the predetermined number of charge cycles: read a current voltage of the battery; compare the current voltage and the initial voltage; and determine that the battery is faulty based on the current voltage not being greater than the initial voltage.

### BRIEF DESCRIPTION OF THE DRAWINGS

The foregoing features of embodiments will be more readily understood by reference to the following detailed description, taken with reference to the accompanying drawings, in which:

FIG. 1 illustrates an exemplary embodiment of the restoration device.

FIG. 2 illustrates the secondary portion of the circuit of the exemplary embodiment of the restoration device.

FIG. 3 illustrates an exemplary embodiment of the restoration process.

FIG. 4 illustrates a microprocessor in an exemplary embodiment of the present invention.

### DETAILED DESCRIPTION OF SPECIFIC EMBODIMENTS

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Reference in this specification to “one embodiment,” “an embodiment,” “an exemplary embodiment,” or “a preferred embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

An exemplary embodiment of the restoration device of the present invention restores a battery to working condition and for extending the life expectancy of the battery. During a restoration process, the restoration device cycles the battery with a small current and with a constant voltage for a predetermined period of time for a predetermined number of cycles in a set of cycles. The restoration device load tests the battery after performing the set of cycles to excite the battery electrolyte. A microprocessor in the restoration device is configured to sample the battery charge after the set of cycles complete to check and verify that the battery is accepting and holding the charge. Once the battery is verified as holding the charge, the restoration device performs a normal charging cycle. If the battery cannot be verified as holding the charge, then the restoration device outputs a message indicating that the battery is faulty. The exemplary embodiment of the restoration device includes a dual input charge control capable of accepting power in an AC mode (e.g., from a home receptacle) or from alternative source in a DC mode. The restoration process is monitored by the microprocessor configured to manage the charging cycles and to inform the user of the progress of the restoration by displaying digital messages on the display. The restoration device additionally includes an electronic load circuit for load testing the battery during the restoration process to check whether the battery is accepting the energy being restored.

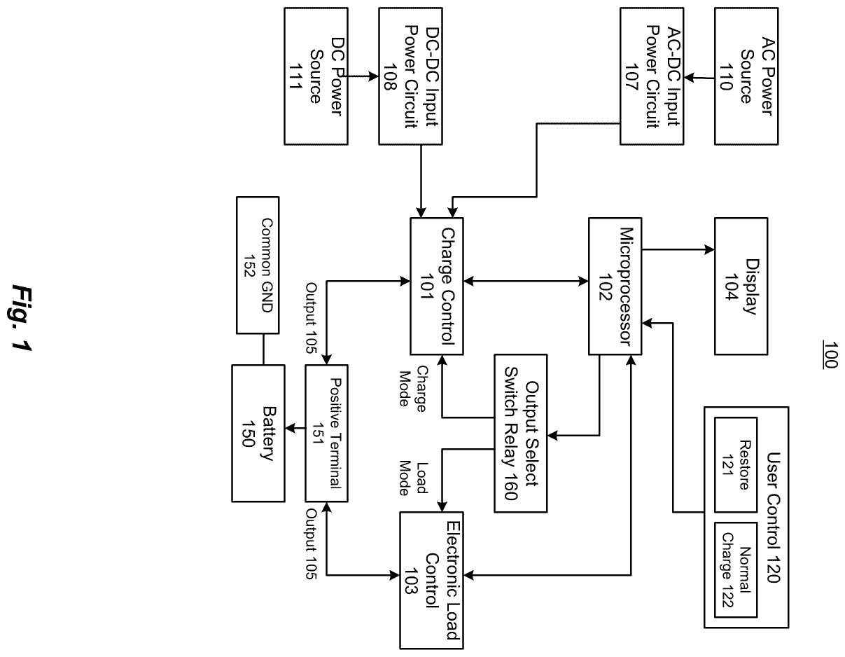

FIG. 1 illustrates the functionality and essential elements of an exemplary embodiment of the restoration device. The restoration device 100 includes a dual input charge control 101 capable of connecting to an AC power source 110 (e.g., a standard home electrical outlet) via an AC-DC input power circuit 107 or a DC power source 111 (e.g., a vehicle's electrical system) via a DC-DC input power circuit 108. One of these two sources and connection types provide the power to restore the battery. The restoration device 100 is configured to be portable, and its ability to accept dual energy sources gives the restoration device 100 the versatility to work in locations without home electrical systems and/or which has alternative power sources, such as solar panels.

The restoration device 100 includes a microprocessor 102 configured to perform and monitor the restoration process. Alternatively, a microcontroller may be used. The microprocessor 102 is programmed to track the variabilities between the output 105 coupled to a positive terminal 151 of a battery 150 and the electronic load control 103, and between the output 105 and the charge control 101, during the set of cycles. The battery 150 is also coupled to a common ground 152. The microprocessor 102 uses an internal volatile memory segment (not shown) to monitor the restoration process in real time, by sampling charge from the battery 150 using the electronic load control 103 during each cycle. Any information relevant to the process can be displayed on the digital display 104 by the microprocessor 102.

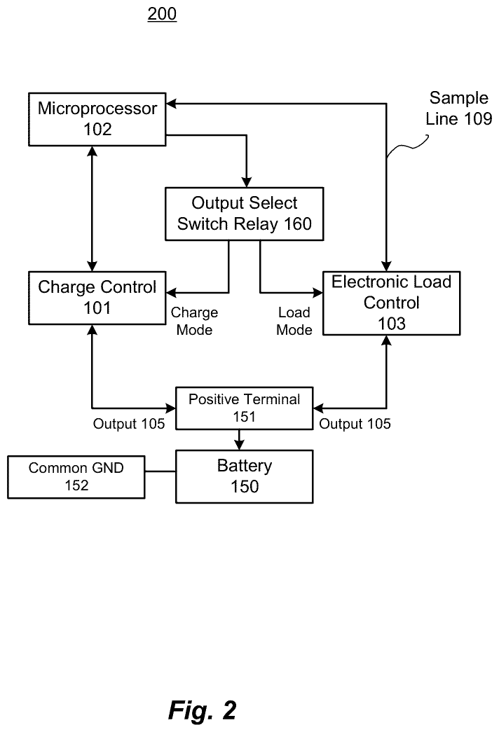

The restoration process begins with the connection of the AC-DC or DC-DC input power circuits 107-108 to a corresponding power source 110-111. The AC-DC input power circuit 107 is coupled to an AC power cord (not shown) for direct connection to an AC power source 110, such as a standard home electrical outlet. The DC-DC input power circuit 108 is coupled to a DC power cord for direct connection to a DC power source 111, such as a standard vehicle's electrical system. A DC plug (not shown) coupled to one end of the DC power cord can be of any type, such as clamps, plug, or ring terminal. Next, the microprocessor 102 monitors and controls the input portion of the input circuit 107 or 108. The microprocessor 102 checks the secondary portion of the circuit 200, shown in FIG. 2, for proper connection and signal generation to the output 105. Once proper connection is verified, the microprocessor 102 load tests the battery 150 using the electronic load control 103.

As illustrated in FIG. 2, the secondary portion of the circuit 200 includes the electronic load control 103 and the charge control 101. The microprocessor 102 toggles between a charge mode and a load mode via an output select switch relay 160. When the output select switch relay 160 is set to the charge mode, the charge control 101 is activated to output a charge to the battery 150. When the output select switch relay 160 is set to the load mode, an electronic load control 103 applies a load to the output 105 to the battery 150. When in the load mode, the load energy at the output 105 is sent to the microprocessor 102 via the sample line 109 for analysis. If the microprocessor 102 determines that the battery 150 requires restoration, then the microprocessor 102 starts a slow charge cycle for a predetermined period of time. At the end of the charge cycle, the microprocessor 102 waits for an expiration of a rest period. The charge cycle is repeated for a predetermined number of cycles. If the battery 150 fails to accept a charge after the completion of the predetermined number of cycles, then the microprocessor 102 determines that the battery 150 cannot be restored and displays a failure message on the display 104. The user of the battery 150 can then seek further service of the battery 150. These further services are outside of the scope of the present invention.

In the exemplary embodiment, during the slow charging cycle, the microprocessor 102 activates the charge control 101 and electronic load control 103, while interacting with the output 105 coupled to a battery 150. The charge control 101 and electronic load control 103 combination excites the electrolyte in the battery 150 by inputting charge through the charge control 101 and then draining some of the charge through the electronic load control 103. This “give-and-take” process forces the electrolyte in the battery 150 to gradually wake up while exciting the acid. The microprocessor 102 performs this cycle for a predetermined number of cycles and at a predetermined interval. After performing the predetermined number of cycles, the microprocessor 102 determines whether the battery 150 is holding the charge by comparing the current and initial voltages of the battery 150. If the microprocessor 102 determines that the battery 150 is holding the charge, then a normal charge cycle is performed. Otherwise, a faulty battery message is output.

In some embodiments, a normal charge cycle includes a three stage process: an initial bulk stage; an absorption stage; and a float stage. During the initial bulk stage, a maximum current is delivered to the battery according to a rating provided by the battery manufacturer, and the battery is charged to approximately 80% of charge, e.g., 13.5-14.0V, based on a superficial battery voltage readout. During the absorption stage, the charger voltage becomes stable and constant at approximately 14.0-14.5V, while the current begins to decline to approximately 1A. During the float stage, the charger tops off the battery at a current lower than 1A and with a voltage up to 14.5V until the battery reaches 100% of charge. The values and percentages are illustrative only and may vary depending on the type of battery charger and type of battery.

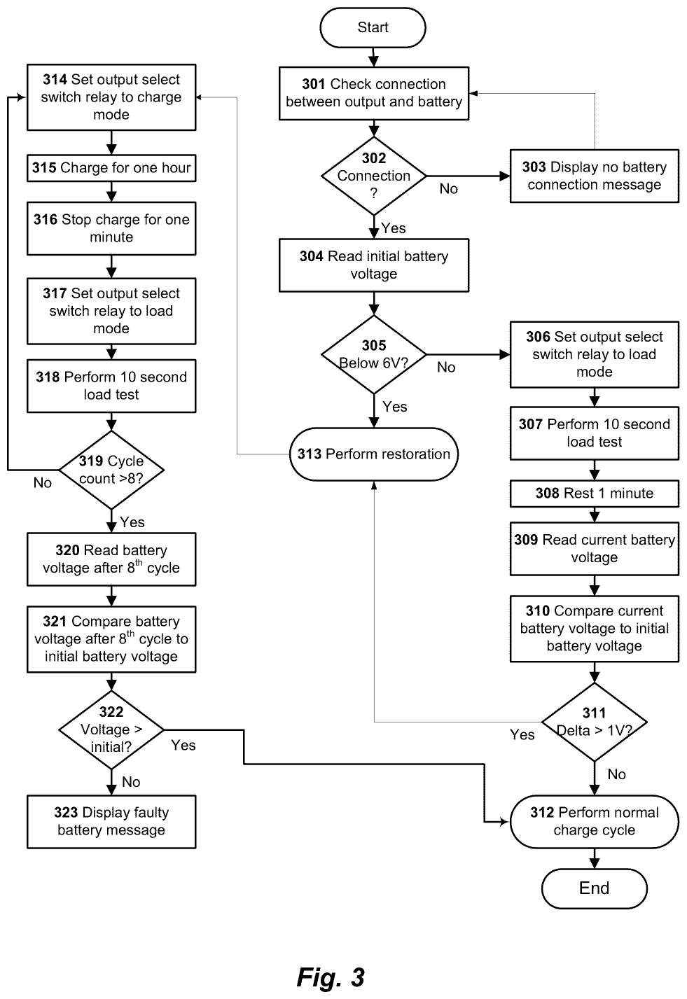

FIG. 3 illustrates an exemplary embodiment of the restoration process. The microprocessor checks for a connection between the output 105 and the battery 150 (block 301). If there is no connection, then the microprocessor 102 displays a ‘no battery connection’ message (303). If there is a connection, then the microprocessor 102 reads the initial voltage of the battery 150 (block 304) by setting the output select switch relay 160 to the load mode and sampling the voltage at the output 105. The microprocessor 102 then determines whether the initial voltage of the battery 150 is currently below a first threshold voltage, e.g., 6V (block 305). The first threshold voltage can be configured based on a voltage below which the battery cannot hold a minimum charge due to, possibly, the cells of the battery 150 becoming sulfated. Sulfation in a lead acid battery refers to the buildup of lead sulfate crystals on the battery plates. This may occur when the battery is not fully charged or is stored for extended periods in a discharged state. If the initial voltage of the battery 150 is not below 6V, then the microprocessor 102 sets the output select switch relay 160 to the load mode (306), which causes the electronic load control 103 to apply a load (e.g., 1A-5A) to the output 105 in order to perform a load test. The microprocessor 102 performs a load test for a predetermined period of time, e.g., 10 seconds (block 307), followed by a rest period, e.g., for 1 minutes (block 308). After the expiration of the rest period, the microprocessor 102 reads the current battery voltage (block 309) and compares the current battery voltage to the initial battery voltage that was read at block 304 (block 310). If the delta between the current battery voltage and the initial battery voltage is above a second threshold voltage, e.g., 1V (block 311), then the microprocessor 102 performs a normal charge cycle (block 312). Otherwise, the microprocessor 102 determines that the battery 150 required restoration (block 313). The second threshold voltage can be configured based on a delta above which indicates that the battery 150 cannot hold the minimum charge.

Referring still to FIG. 3, blocks 314-323 illustrates an exemplary embodiment of the restoration process. The restoration process begins with a first charge cycle. In the first charge cycle, the microprocessor 102 sets the output select switch relay 160 to the charge mode (block 314), which causes the charge control 101 to supply charge to the output 105. The battery 150 is then charged for a predetermined charge time period, e.g., one hour (block 315). Upon the expiration of the charge time period, then microprocessor 102 stops the charge for a predetermined rest time period, e.g., one minute (block 316). Upon the expiration of the rest time period, the microprocessor 102 sets the output select switch relay to the load mode (block 317), which causes the electronic load control 103 to apply a load to the output 105. This load test is performed for a predetermined load time period, e.g., 10 seconds (block 318). Upon the expiration of the load time period, the microprocessor 102 determines whether the predetermined number of charge cycles has been reached (block 319). In this exemplary embodiment, the number of charge cycles is set to eight. A counter may be used to track the number of charge cycles, where the counter is incremented at the end of each charge cycle. If the number of charge cycles has not been reached, then the microprocessor 102 repeats the charge cycle (blocks 314-318). After the number of charge cycles has reached eight (block 319), the microprocessor 102 reads the battery voltage (block 320) and compares the battery voltage after the 8th cycle with the initial battery voltage read at block 304 (block 321). If the battery voltage after the 8th cycle is greater than the initial battery voltage (block 322), this indicates that the battery 150 is holding the charge. The microprocessor 102 then performs a normal charge cycle (block 312). If the battery voltage after the 8th cycle is not greater than the initial battery voltage (block 322), this indicates that the battery 150 is not holding the charge. The microprocessor 102 then displays a faulty battery message (323).

Referring to FIGS. 1 and 3, the restoration device 100 optionally includes user controls 120 for manual operation. A user may engage a restore user control 121 to manually initiate the restoration process or engage a normal charge user control 122 to manually initiate a normal charge cycle. When the restore user control 121 is engaged, the restoration device performs the restoration process (blocks 314-323, FIG. 3) without performing the initial voltage check (blocks 305-311, FIG. 3). When the normal charge user control 121 is engaged, the initial voltage check (blocks 305-311) is performed, and the microprocessor 102 performs the restoration process (blocks 314-323) based on the delta value (see block 311).

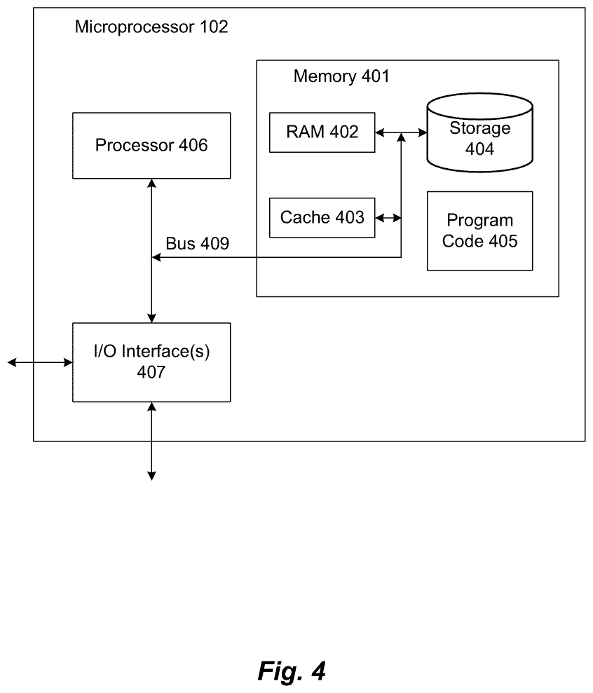

FIG. 4 illustrates a microprocessor in an exemplary embodiment of the present invention. The microprocessor 102 is operationally coupled to a processor or processing units 406, a memory 401, and a bus 409 that couples various system components, including the memory 401 to the processor 406. The bus 409 represents one or more of any of several types of bus structure, including a memory bus or memory controller, a peripheral bus, an accelerated graphics port, and a processor or local bus using any of a variety of bus architectures. The memory 401 may include computer readable media in the form of volatile memory, such as random access memory (RAM) 402 or cache memory 403, or non-volatile storage media 404. The memory 401 may include at least one program product having a set of at least one program code module 405 that are configured to carry out the functions of embodiment of the present invention when executed by the processor 406. The microprocessor 102 may also communicate with one or more external devices via I/O interfaces 407.

The present invention can take the form of an embodiment containing both hardware and software elements. In a preferred embodiment, the present invention is implemented using software, which includes but is not limited to firmware, resident software, microcode, etc.

Furthermore, the present invention can include a computer readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Without limitation, potential subject matter that may be claimed (prefaced with the letter “P” so as to avoid confusion with the actual claims presented below) includes:

Clause 1. A restoration device for restoring a battery, comprising: a microprocessor configured to: read an initial voltage of the battery; determine if the battery requires restoration; in response to determining that the battery requires restoration, perform a predetermined number of charge cycles, each charge cycle comprising: charge the battery for a predetermined charge time period; and after expiration of the charge time period, perform a load test for a load time period; after performing the predetermined number of charge cycles: read a current voltage of the battery; compare the current voltage and the initial voltage; and determine that the battery is faulty based on the current voltage not being greater than the initial voltage.

Clause 2. The device of clause 1, where the microprocessor configured to perform the load test for the load time period is further configured to: after the expiration of the charge time period, apply a rest period; and after expiration of the rest period, perform the load test for the load time period.

Clause 3. The device of clause 1, wherein the microprocessor configured to determine if the battery requires restoration is further configured to: determine if the initial voltage is below a first voltage threshold; and determine that the battery requires restoration based on the initial voltage being below the first voltage threshold.

Clause 4. The device of clause 3, wherein the first voltage threshold is configured based on a voltage below which the battery cannot hold a minimum charge.

Clause 5. The device of clause 1, wherein the microprocessor is further configured to: in response to determining that the battery does not require restoration: perform a second load test for a second load time period; read a second current voltage of the battery; determine a delta between the second current voltage and the initial voltage; and determine that the battery requires restoration based on the delta being above a second voltage threshold.

Clause 6. The device of clause 5, wherein the second voltage threshold is configured based on a delta above which indicates that the battery cannot hold a minimum charge.

Clause 7. The device of clause 5, wherein the microprocessor is further configured to: in response to the delta not being above the second voltage threshold, perform a normal charge cycle.

Clause 8. The device of clause 1, wherein the microprocessor is further configured to: in response to the current voltage being greater than the initial voltage, perform a normal charge cycle.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the disclosure.

What is claimed is:

1. A restoration device for restoring a battery, comprising:
a microprocessor configured to:
read an initial voltage of the battery;
determine if the battery requires restoration;
in response to determining that the battery requires restoration, perform a predetermined number of charge cycles, each charge cycle comprising:
charge the battery for a predetermined charge time period; and
after expiration of the charge time period, perform a load test for a load time period;
after performing the predetermined number of charge cycles:
read a current voltage of the battery;
compare the current voltage and the initial voltage; and
determine that the battery is faulty based on the current voltage not being greater than the initial voltage.

2. The device of claim 1, where the microprocessor configured to perform the load test for the load time period is further configured to:
after the expiration of the charge time period, apply a rest period; and
after expiration of the rest period, perform the load test for the load time period.

3. The device of claim 1, wherein the microprocessor configured to determine if the battery requires restoration is further configured to:
determine if the initial voltage is below a first voltage threshold; and
determine that the battery requires restoration based on the initial voltage being below the first voltage threshold.

4. The device of claim 3, wherein the first voltage threshold is configured based on a voltage below which the battery cannot hold a minimum charge.

5. The device of claim 1, wherein the microprocessor is further configured to: in response to determining that the battery does not require restoration:
perform a second load test for a second load time period;
read a second current voltage of the battery;
determine a delta between the second current voltage and the initial voltage; and
determine that the battery requires restoration based on the delta being above a second voltage threshold.

6. The device of claim 5, wherein the second voltage threshold is configured based on a delta above which indicates that the battery cannot hold a minimum charge.

7. The device of claim 5, wherein the microprocessor is further configured to: in response to the delta not being above the second voltage threshold, perform a normal charge cycle.

8. The device of claim 1, wherein the microprocessor is further configured to: in response to the current voltage being greater than the initial voltage, perform a normal charge cycle.
